(19) United States
(12) Patent Application Publication
(10) Pub. No.: US 2009/0226577 A1
(43) Pub. Date: Sep. 10, 2009

(54) METHOD FOR DRYING PISTACHIOS TO ACHIEVE PREFERRED ORGANOLEPTIC CHARACTERISTICS

(76) Inventor: Dave SZEFLIN, Bakersfield, CA (US)

Correspondence Address: DALINA LAW GROUP, P.C., 7910 IVANHOE AVE. #325, LA JOLLA, CA, 92037, US

(21) Appl. No.: 12/042,530

(22) Filed: Mar. 5, 2008

(51) Int. Cl. A23L 1/36; A23L 3/40

(52) U.S. Cl. 426/233; 426/632

(57) ABSTRACT

The invention is directed toward a method and system to provide a commercial accelerated drying process for pistachios that mimics the natural dehydration process under the sun by controlling the maximum temperature and moisture content of the pistachios during drying, producing nuts with sun-dried organoleptic characteristics. Embodiments of the invention reduce the moisture content of pistachio nuts with a heated airflow in a temperature controlled environment using any commercial nut drying system. Using the methods described herein, pistachios can be produced with sun-dried flavors characteristics in a controlled environment free of dependence on weather conditions.

### BACKGROUND OF THE INVENTION

1. Field of the Invention

Embodiments of the invention described herein pertain to a method and apparatus for drying nuts, and more particularly to a method and apparatus for drying pistachios to achieve preferred organoleptic characteristics using heated airflow to reduce the moisture content.

2. Description of the Related Art

Pistachio (Pistacia vera) is a dioecious tree in the sumac family (Anacardiaceae). Like the almond, the pistachio fruit is drupaceous with a fleshy, greenish outer layer surrounding the hard, seed-bearing shell. The edible kernel has a papery seed coat and two greenish cotyledons. The kernels are a good source of lipids (50-60%) and contain unsaturated fatty acids. Primary commercial sources of pistachio nuts are Iran, Turkey and the United States. Pistachio nuts develop preferred organoleptic characteristics such as color, taste, and smell during the drying and/or roasting process.

Drying is one of the methods of conserving pistachio nuts. Drying is a well-known food preservation technique to reduce the moisture contents of nuts, which prevents spoilage and deterioration during a storage period. The quality and value of pistachio nuts are greatly influenced by the drying process used. Nuts that have been dried at lower temperature exhibit better storage stability but require longer processing time. Lower moisture content retards or eliminates the growth of microorganisms, but may results in higher lipid oxidation rates. Lipid oxidation in some nuts is associated with unsaturated fatty acids and it is often autocatalytic, with oxidation products themselves catalyzing the reaction thus the rate increases with time. Due to high lipid content and richness in unsaturated fatty acid, pistachio nuts are a very sensitive to potential rancidity.

The traditional sun-drying method for processing pistachios is an ancient and rudimentary process. The pistachio fruits are harvested from trees, dehulled to separate the soft hull from nuts, washed to clean the nuts, and sun-dried on drying ground or concrete slabs in thin layers, usually for a period of several days. The nuts are heated by solar radiation from above and by secondary radiation from the already warmed concrete surface below, while natural circulation of relatively dry air over the top of the nuts slowly leaches out the moisture. They are sometimes covered at night to protect them from reabsorbing moisture during the nighttime dew point and temperature changes. Sun-dried pistachios have been found to have superior flavor compared to pistachios dried under current commercial practices that include using air dryer equipment to speed the drying process. This approach tends to leave the pistachios with less than ideal organoleptic characteristics.

However, the traditional method of drying in the open sun is also a disadvantage because of the required drying time, as well as because it exposes the crop to dirt, dusts, insect pests, harmful microorganisms and changing weather conditions. Sun-drying also makes it difficult to safeguard the pistachios from excess moisture, which is a particular concern because of the possible growth of microorganisms during the drying process. Contamination by microorganisms may dramatically decrease the value of the crop. Other problems with drying pistachio nuts in the open sun include that it is inefficient, labor-intensive and requires lengthy sun-drying time where nuts must be arranged on open-air slabs. Over the years, other manual, passive solar methods and devices have been created to attempt to promote and control air movement in combination with heat for drying nuts, but these methods have not been commercially successful. Modernly, nuts are dried by supporting them on a foraminous surface or in a container having at least foraminous bottom surface or screen. This method permits a greater degree of air circulation with both the top and bottom of the nuts.

Various electrical and solar systems, as well as fuel-fired drying systems using heat and airflow have also been used to try to accelerate nut drying time. These devices include bin dryers, bed dryers, vertical continuous dryers, vertical cylindrical dryers, and funnel vertical dryers. However, these accelerated methods may over-dry the nuts; over-drying has a negative affect on the quality and value of the crop. During the accelerated drying process, nuts may undergo undesirable reactions such as rancidity that cause degradation of quality including odd colors and flavors. Accelerated drying temperature may also affect the sensory attributes of pistachio nuts, including their firmness, sweetness, split shell, shell appearance, and overall palatability.

Solar-powered drying apparatus also fail to produce nuts with the desired characteristics of flavor, texture, color, appearance and other organoleptic characteristics of nuts produced using a traditional method of sun drying. The internal temperature of nuts undergoing the drying process in a solar drying apparatus has been found to exceed the peak internal temperature of the same nuts dried using the traditional sun drying method. Thus, high temperatures used in solar powered drying systems also degrade the palatability and wholesomeness of the nuts.

Another commercial alternative is to dry the pistachio nut by roasting. Roasting dries the pistachios while achieving increased flavor due to the high temperatures applied during the roasting process. Roasting alters and substantially affects the flavor, texture, color and appearance, and is one of the most common forms of processing for pistachio nuts. Unfortunately, the valuable lipids, proteins and carbohydrates of the pistachio nut may degrade during the roasting process, because the lipids, proteins and carbohydrates are unavoidably exposed to adverse conditions during the heat processing in roasting systems.

For at least the limitations described above there is a need for a commercial drying process for pistachio nuts mimicking the traditional sun drying process to improve organoleptic characteristics of the nuts, while speeding the drying process and protecting the nuts from contamination and other risks of sun-drying.

### BRIEF SUMMARY OF THE INVENTION

Pistachio nuts spread on the ground in a thin layer and dried with natural convection and under a direct sunlight in a sunny atmospheric condition and relatively low humidity over 3 to 4 days were evaluated and discovered to have the most desirable flavors and quality characteristics compared to pistachio nuts from other drying and/or roasting methods. It has been discovered that the reduction of moisture content and water activity in this “thin-layer” natural sun drying process is not linear over time and, most importantly, the internal temperature of the pistachio nuts remains below about 130° F.

One or more embodiments of the invention enable commercial pistachio drying methods using commercial drying equipment that nonetheless produces nuts with sun-dried organoleptic characteristics. The method of the present invention provides an accelerated commercial drying process for pistachios that mimics the natural dehydration process under the sun by carefully controlling the maximum temperature and moisture reduction of the pistachios during the process.

Embodiments of the invention are directed to methods for reducing the moisture content of pistachio nuts with a heated airflow in a temperature controlled environment. In these embodiments, the methods may use any commercial nut drying systems such as, for example, distributed airflow containers with one or more controlled heating circuits for batch drying of pistachios. The methods may use airflow circulation systems with open loop airflow circuits or complex open and closed loop airflow circuits. Using the methods described herein, pistachios can be produced with sun-dried flavors characteristics in a controlled environment free of dependence on sunny weather conditions.

The embodiments of the invention include monitoring the internal temperature and moisture content of pistachios during a drying process and adjusting the drying system to ensure that the internal kernel temperature remains below that which would be experienced by the pistachios during a natural sun-drying process. Internal kernel temperature is controlled by managing the time the pistachios remain in various zones of the dryer (dwell time), by adjusting the speed of the belts, and by controlling the temperature of the airflow in the drying system, all to optimize the drying of nuts to produce exemplary sun-dried flavors characteristic.

In one or more embodiments of the invention, the moisture content of pistachio nuts is reduced from approximately 30% when the pistachios are harvested to about 12% at the completion of the drying process, all the while maintaining the internal temperature of the pistachios in the range of approximately 110° to 140° F. After reducing moisture content to about 12% in the drying system, the pistachios may be further dried to about 5 to 6% humidity in silos or other types of bulk storage containers. In one or more embodiments, the bulk storage container may use circulating ambient or force-heated air to further dry the pistachios. Air temperature in the bulk storage container may be maintained at no more than the temperature the pistachios would experience during the remainder of the natural sun drying process, that being about 100° F. Bulk storage container drying typically lasts three to four days during the method of the invention, depending on the resultant moisture content of the pistachios.

Methods of the invention are directed toward specific management of three control parameters to produce pistachios with superior sun-dried flavors characteristic: internal pistachio kernel temperature, drying time and humidity.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a flow diagram illustrating a traditional pistachio processing method.

FIG. 2 illustrates an optimum moisture reduction curve for pistachios dried using a traditional sun-drying method.

FIG. 3 illustrates a moisture reduction curve for pistachios dried in a drying system.

FIG. 4 illustrates a cross section view of an example of drying system for drying pistachios according to one or more embodiments of the invention.

FIG. 5 illustrates another example of a commercial drying system that may be used with one or more embodiments of the present invention, in particular a conveyor dryer depicted with five drying zones.

### DETAILED DESCRIPTION

A method for drying pistachios to achieve preferred organoleptic characteristics will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

The method disclosed herein for drying pistachios is exemplary and may be applied to other nuts, such as almonds, using characteristics appropriate to those nuts. As used herein, the term “nut” refers to a nutmeat completely or partially surrounded by a shell. The term “kernel” refers to nutmeat having no surrounding shell.

Pistachio nuts spread on the ground in a thin layer and dried with natural convection and under a direct sunlight, typically between 200 and 810 W m⁻², in a sunny atmospheric condition and relatively low humidity over 3 to 4 days were evaluated and discovered to have the most desirable flavors and quality characteristics compared to pistachio nuts from other drying and/or roasting methods. It has been discovered that the reduction of moisture content and water activity in the thin-layer natural sun drying process is not linear over time and, most importantly, the internal kernel temperature of the pistachio nuts preferably remains below about 130° F.

One or more embodiments of the invention enable pistachio drying methods that produce nuts with sun-dried organoleptic characteristics. The method of the present invention provides an accelerated commercial drying process for pistachios that mimics the natural dehydration process under the sun by carefully controlling the maximum temperature and moisture content of the pistachios during the process.

The ideal peak internal humidity for pistachios was determined by measuring the moisture content of pistachios at several points during a traditional sun-drying process. This process may be reproduced using a conventional moisture measurement method such as the Oven Moisture Standard Method or the Mettler Moisture Method. The temperature of the ambient air is not accurate measurement for the internal temperature of drying pistachios. The peak internal temperature for pistachios during the hottest point of the traditional sun-drying process was measured by taking a sample into a thermos and measuring the temperature with a thermometer to determine the pistachio kernel temperature.

The method of the present invention mimics the sun-drying process described herein by utilizing the pistachio kernel temperature and humidity data in a commercially practical drying process using conventional commercial drying systems, but controlling those drying systems in a way that produces pistachios with the highly desirable sun-dried organoleptic characteristics.

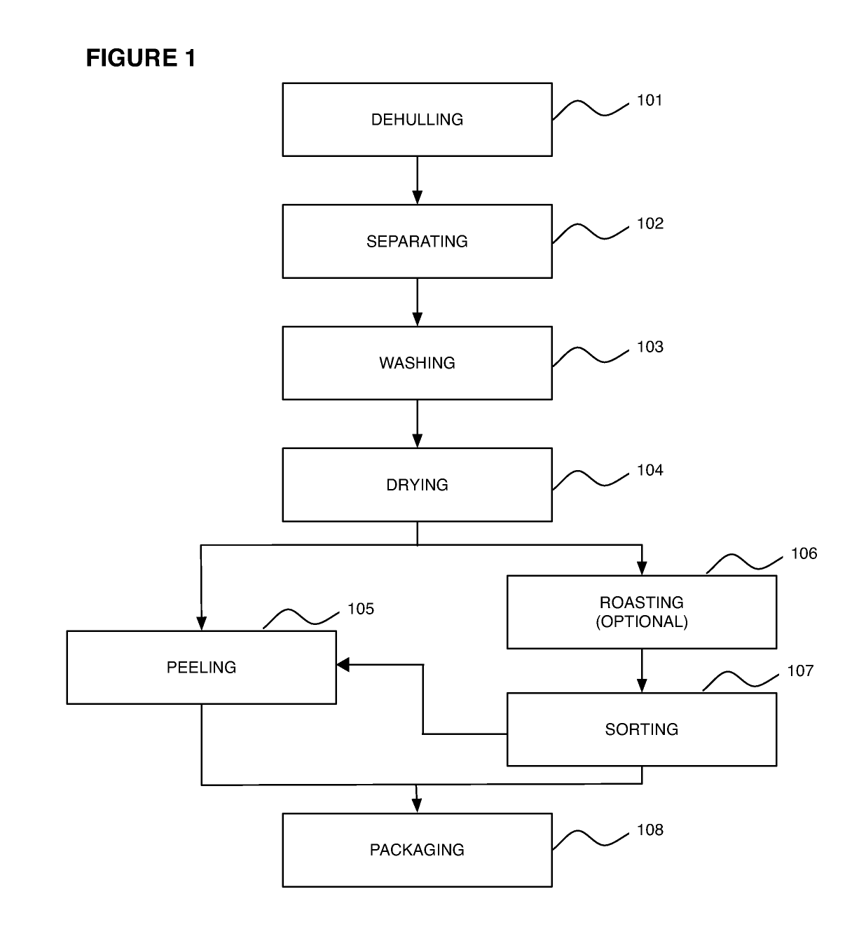

FIG. 1 is a flow diagram illustrating traditional pistachio processing following harvesting. Bulk pistachios are received at the processing plant. The processing of pistachios typically begins with dehulling step 101 to separate the hull and nut. In separating step 102, dehulled nuts are separated from the mixture of nuts and hulls. The freshly dehulled nuts generally have a moisture content of around 30-45%. Pistachio nuts are cleaned in washing step 103 which optionally may include soaking the nuts in a brine solution to add flavor. The moisture content of the pistachios is reduced in drying step 104. The drying steps disclosed herein require reduction of the moisture so that the water activity of pistachios is such that microbial growth will be inhibited, and is further described herein.

A batch of dried pistachio nuts may undergo peeling step 105 to extract pistachio kernels from shells. Pistachio kernels then undergo packaging step 108 to package the kernels for distribution or for sale.

After drying, a batch of dried pistachio nuts may undergo an optional step of roasting 106. Before roasting pistachio nuts undergo sorting step 107 in which the nuts are graded and sorted based on size and/or whether or not the shell has split open. A typical harvest of pistachio nuts comprises about 17% with a closed shell, 5% with a thinly split shell, and 78% with a fully open shell. Nuts with closed shells have a low consumer acceptance because they are difficult to open and may contain immature kernels. Pistachio nuts with closed shells after sorting step 107 may be diverted to peeling step 105. After the nuts have been sorted at the step 107, they may be optionally flavored. For those which are to be roasted and/or flavored however, any conventional commercial apparatus and conditions may be utilized. Sorted pistachio nuts then undergo packaging step 108 to package different size, color and/or quality of pistachio nuts for distribution or for sale. Consumers generally prefer bigger pistachio nuts with fully open shells.

Drying or roasting a pistachio will develop the typical roasted- or toasted-nut flavor. Nut lipids are very important precursors for roasted- or toasted-nut flavors, and the protein and carbohydrate components also play a part as flavor precursors during heating, via the Maillard reaction. Two types of flavor compounds are responsible for heated nut flavors. Lactones, such as g-octalactone and g-decalactone, derived from direct, thermally induced lipid degradation, are the first type of compounds. Heterocyclic nitrogen or oxygen compounds such as pyrazines and furans are the second type of flavor compounds. The same components that play a part in the pistachio's texture and flavor attributes provide many nutritional benefits.

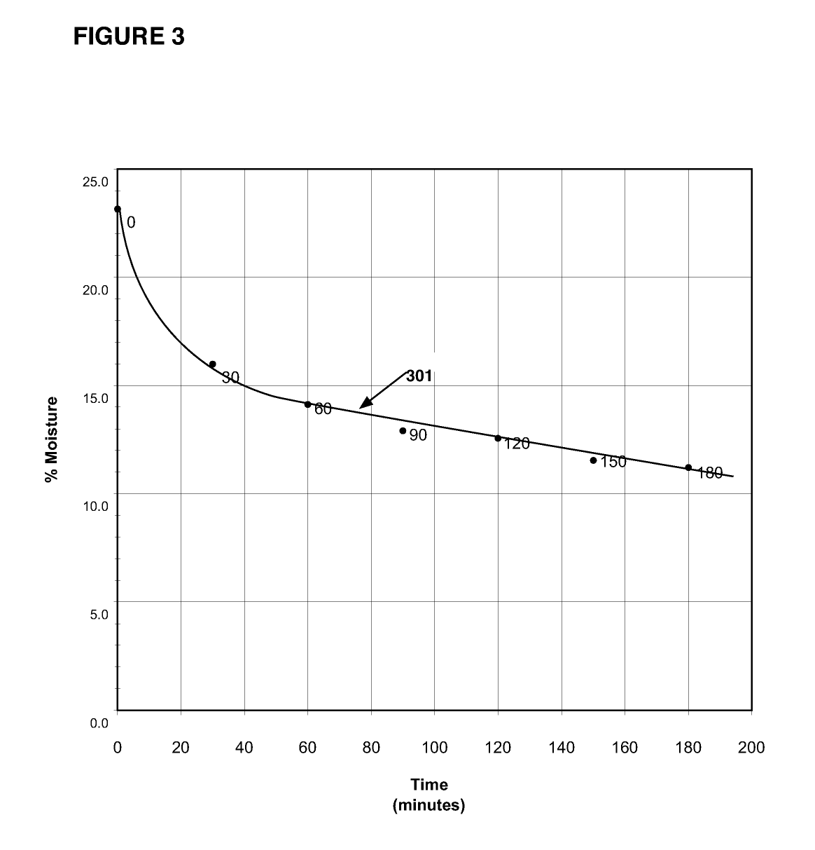

By using one or more embodiments of the inventive methods described herein that mimic the traditional sun-drying process, pistachio nuts with organoleptic properties of sun-dried pistachio nuts may be created in a highly controlled commercial environment. The methods use a thermal drying process that reduces moisture content under temperature and moisture reduction conditions based on that of the traditional sun-drying process, but achieve the result in a shortened period of time preferable for commercial pistachio processing. In effect, “sun dried” pistachios can be “created” in a gas fired dryer if the drying curve of FIG. 3 is followed, and the internal kernel temperature remains below about 130° F. This first drying step may occur in about two hours in a commercial dryer, instead of the three to four days required on concrete slabs in the traditional sun-drying process. The present invention is not limited to any particular type of drying system.

Optimum control parameters for pistachio nuts in the present invention fall within the following conditions: a first step considerably reduces the moisture in the pistachios by heating the nuts evenly throughout at a kernel temperature at about 125° to 130° F. Air temperatures in the broader range of about 110° F. to 140° F. may also produce the desired organoleptic characteristics. However, it has been found that temperatures over 140° F. using the method described herein will not produce the desired organoleptic characteristics in pistachio nuts.

The internal pistachio kernel temperature may be measured by placing a sample of nuts with a temperature measuring device such as a thermocouple, thermister, digital temperature probe, or thermometer inside a closed thermal insulated container such as a thermos and allowing the system come to equilibrium before taking the temperature measurement. In a preferred embodiment, pistachio kernel temperature is measured hourly by removing samples from the dryer and checking the temperature as described above.

In a preferred embodiment, the method of the present invention includes a second drying step where the pistachios are moved from the dryer into a storage bin, such as a silo, to allow an additional gradual moisture reduction by drying the nuts with a circulating air of temperature of about 60° to 100° F. until the moisture content of the nuts is reduced to around 4 to 6%, or preferably 5%. In the summer, this second drying period may use ambient air. However, near the end of the growing season when daytime temperatures may drop below about 60° F., it is preferred to warm the air in the silo with heaters, though temperatures above 100° F. in this second drying period are not effective for producing the desired organoleptic characteristics

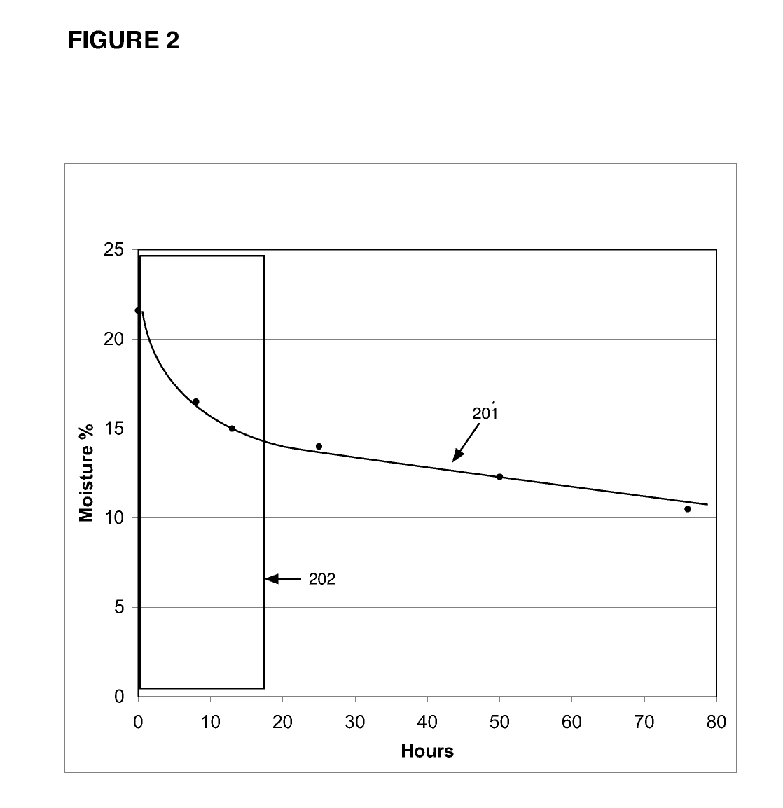

The second drying period is used to stabilize and equilibrate the pistachio nuts using a gradual moisture reduction process that corresponds to the later stage of the sun-drying process as illustrated in FIG. 2. It is contemplated by the present invention that pistachio nuts may go through only one drying period of heating the nuts evenly at the internal kernel temperature to a preferred temperature of about 125° to 130° F. until the moisture content of the nuts is reduced to around 4 to 6%, as long the moisture reduction process follows that of the curve illustrated in FIG. 2.

FIG. 2 illustrates a drying curve 201 for shelled pistachio nuts spread on the ground in a thin layer and dried with natural convection and under a direct sunlight in a sunny atmospheric condition and relatively low humidity over 3 to 4 days, as is the traditional drying method used in locations such as Iran, which are known to produce pistachios of superior organoleptic characteristics. Before and during the sun-drying process, moisture contents of pistachio samples collected at different time points were determined by a conventional moisture measurement method. For example, moisture contents of the nut samples were determined by collecting 50 g of each sample from different time points is put down in the high-temperature oven, kept there at 110° C. over 3.5 days, and then weighted to determine dry basis. It was discovered that the moisture reduction in the pistachio nuts, shelled or unshelled, from the thin-layer natural sun drying process is not linear over a period of time and the internal kernel temperature of the pistachio nuts peaks at about 130° F. As shown in FIG. 2, a rapid moisture loss 202 of the pistachio nuts occurs during the initial period of the drying process.

One or more embodiments of the method of the present invention may use any drying systems that provide a controlled rate of moisture reduction or drying of agricultural product to control the internal kernel temperature of the pistachio nuts. Such drying systems may include, but are not limited to, tray dryers, belt dryers, vertical fluidized bed ovens, horizontal fluidized bed ovens, spray dryers, impingement ovens, bin dryers, bed dryers, vertical continuous dryers, vertical cylindrical dryers, and funnel vertical dryers. Drying systems may have one or more drying zones, each zone providing different or similar drying conditions. Drying systems may use airflow circulation systems with open loop airflow circuits or complex open and closed loop airflow circuits.

Drying systems may use any apparatus for controlling the water content of recirculating air in the drying system, such as controlling the water vapor content by impingement heating, or by combining the recirculating air with relatively drier outside air to reduce the degree of saturation of the recirculated air. The moisture content of materials in such dryers may be controlled by varying the input rate of the material to be processed through the drying system in combination with the regulation of the pressure, velocity, temperature and humidity of the air supplied to the inlet duct and the adjustment of the dwell time and movement of the pistachio nuts through one or more zones of the drying system. In particular, controlling the dwell time and belt speed of the dryers may also be effective in managing the internal kernel temperature of the pistachios.

FIG. 3 illustrates a moisture reduction curve for pistachio nuts dried in a drying system with drying parameters set up to simulate the sun drying curve. The drying system provided a drying period allowing for a considerable moisture reduction exhibiting a sun drying-like curve 301 by heating the nuts evenly throughout at the kernel temperature at about 125° to 130° F. such that the moisture reduction correspond to initial rapid moisture loss 202 of sun drying curve as shown in the FIG. 2. Using relatively high heat for the drying period, it may not be necessary to monitor humidity of the circulating air in the drying system as long the moisture reduction takes place following the sun drying curve.

After reducing the moisture content of pistachio nuts to about 12% in the first drying period period, pistachio nuts may then be transferred to bulk storage containers such as storage silos, which also serve as second-stage drying systems. For the second drying step, where the moisture reduction of pistachio nuts is gradually reduced to about 2 to 6%, or more typically to about 5%, over about three to four days. Such second-stage drying systems may be configured to circulate air to flow through the bulk of pistachio nuts to effect additional drying that corresponds to the tail end of the sun drying curve of FIG. 2. Storage silos may have foraminous subfloors, ducts and blowers to circulate air which may be warm ambient air or heated air. Typically when simulating the gradual drying curve as in the tail end of the sun drying curve of FIG. 2, the gradual moisture reduction is generally accomplished with slow moving, steady and warm dry air. In the case of pistachios, the second drying period for gradual drying curve use air temperatures that remain below 100° F. and the second-stage drying system may use the circulating air from outside during a sunny or warm summer weather.

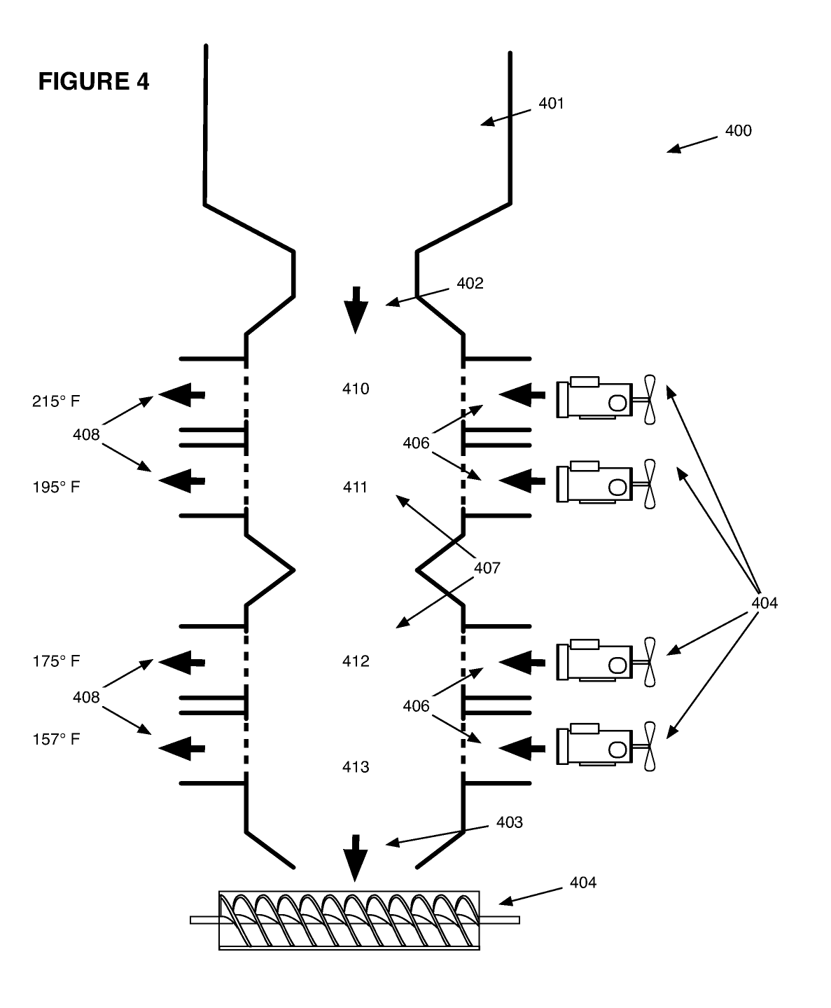

FIG. 4 is a cross section view of an example of industrial drying system for drying pistachios pursuant to one or more embodiments of the invention. The drying system as shown in FIG. 4 is a vertical continuous dryer 400 with a cross-flow configuration depicted with four drying zones 410 411 412 413. Bulk pistachio nuts are loaded into infeed container 401 of the drying system. Pistachio nuts travel down from the top portion 402 to the bottom portion 403 and the dwell time or the rate of travel of pistachio nuts is controlled by a discharge mechanism 404. Blowers 405 supply drying air which moves horizontally from inlets 406 through screens into chambers 407 where the drying air carries out moisture from pistachio nuts out of chambers 407 through outlets 408. Any conventional apparatus such as heater, condensers, and humidifiers may be utilized to provide heat in the drying air. The drying system provides first drying step, reducing the moisture content of pistachio nuts to about 12% in about two hours. The blowers supplying the drying air at the velocity, humidity and temperature which depends on the volume and amount of pistachio nuts moving through the drying zones as long as the internal kernel temperature remains below the peak internal kernel temperature of the nuts in the traditional sun-drying process reflected in FIG. 2. The rate of moisture reduction may be independent and separately controlled in each drying zone. For example, the drying air in the drying zone 410 may be hotter and flow faster than the drying air in the drying zone 413 as the temperature of the pistachio nuts initially climbs towards the peak temperature at the beginning of the process.

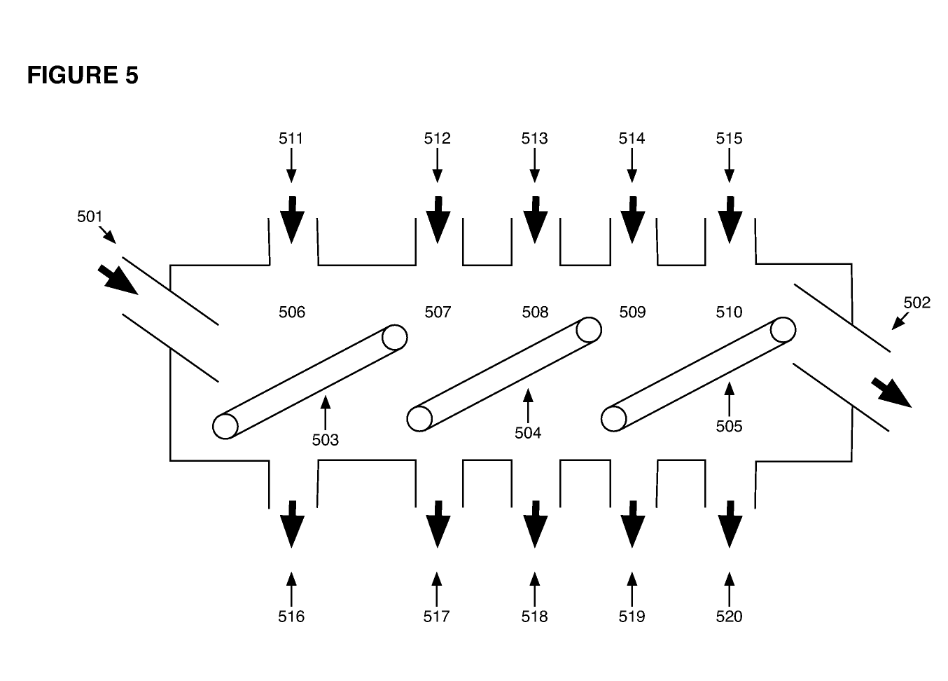

FIG. 5 is a cross section view of another example of commercial drying system for drying pistachio nuts pursuant to one or more embodiments of the invention. The drying system as shown in FIG. 5 is a conveyor dryer 500 depicted with five drying zones 506 507 508 509 510. Bulk pistachio nuts enter the drying system through the infeed chute 501. The pistachios travel in a thin layer on the top portions of conveyors 503 504 505 and exit the drying system through outfeed chute 502. The dwell time or the rate of travel of the pistachios is independently controlled by the conveyors 503 504 505 506. The conveyors may have foraminous belt to permit the passage of air but not the pistachios through the belt. Blowers supply drying air which moves vertically from inlets 511 512 513 514 515 into a chamber where the drying air carry out moisture from the pistachios out of the chamber through outlets 516 517 518 519 520. The parameters controlling the moisture reduction of the pistachios are the velocity, humidity and temperature of the drying air supplied by the inlets, such as from blowers and/or heaters, and the dwell time of the pistachios by the speed of the nuts moving through the drying zones on the conveyors. The rate of moisture reduction is independent and separately controlled on each conveyor. For example, the drying air in the first drying zone may be hotter, more humid and flow faster than the later drying zone. To obtain organoleptic characteristics of sun-dried pistachios, the internal kernel temperature is measured during the drying period, and the parameters of the drying system are adjusted so that the internal temperature of the pistachios remains below the peak internal temperature of the sun drying process. In a preferred embodiment, the internal kernel temperature is measured at least hourly.

While the invention herein disclosed has been described by means of specific embodiments and applications thereof, numerous modifications and variations could be made thereto by those skilled in the art without departing from the scope of the invention set forth in the claims.

What is claimed is:

1. A method for drying pistachios to achieve preferred organoleptic characteristics comprising:
placing pistachios into a nut drying system;
utilizing monitoring to determine when to adjust said drying system's parameters using a method comprising:
controlling a temperature of said drying system such that a kernel temperature of said pistachios remains below about 130° F.; and
heating said pistachios in said drying system until a humidity of said pistachios is reduced to about 5%.

2. The method of claim 1 further comprising wherein said monitoring is performed by a computer programmed with statistical process control software to control said temperature of said drying system

3. The method of claim 2 wherein said monitoring further comprises:
taking a sample of said pistachios from said drying system;
putting said sample and a temperature measuring device into a thermal insulated container; and
determining said kernel temperature using said temperature measuring device.

4. The method of claim 3 further comprising inputting said determined kernel temperature into said statistical process control software.

5. The method of claim 1 wherein said drying system is selected from a group consisting of tray dryers, belt dryers, vertical fluidized bed ovens, horizontal fluidized bed ovens, spray dryers, impingement ovens, bin dryers, bed dryers, vertical continuous dryers, vertical cylindrical dryers, and funnel vertical dryers.

6. A method for drying pistachios to achieve preferred organoleptic characteristics comprising:
placing pistachios into a commercial nut drying system;
utilizing monitoring to determine when to adjust said drying system's parameters using a method comprising:
controlling a temperature of said drying system such that a first kernel temperature of said pistachios remains below about 130° F.; and
heating said pistachios in said drying system until a first humidity of said pistachios is reduced to about 12%;
moving said pistachios from said drying system to a storage container capable of blowing air on said pistachios; and
maintaining said pistachios in said container such that a second kernel temperature of said pistachios remains below about 100° F. until a second humidity of said pistachios is reduced to about 5%.

7. The method of claim 6 wherein said first kernel temperature remains below 125° F.

8. The method of claim 6 wherein said first kernel temperature remains about 110° F.

9. The method of claim 6 wherein said blowing air is heated to no more than about 100° F. when said temperature of said air is less than about 60° F.

10. The method of claim 9 where said blowing air in said container is ambient air.

11. The method of claim 10 further comprising:
wherein said blowing air is heated during daytime; and
wherein said blowing air is turned off at night.

12. The method of claim 6 further comprising wherein said monitoring is performed hourly.

13. The method of claim 6 wherein said monitoring further comprises:
taking a sample of said pistachios from said drying system;
putting said sample and a temperature measuring device into a thermal insulated container; and
determining said first kernel temperature using said temperature measuring device.

14. The method of claim 6 wherein said drying system is selected from a group consisting of tray dryers, belt dryers, vertical fluidized bed ovens, horizontal fluidized bed ovens, spray dryers, impingement ovens, bin dryers, bed dryers, vertical continuous dryers, vertical cylindrical dryers, and funnel vertical dryers.

15. A method for drying pistachios to achieve preferred organoleptic characteristics comprising:
determining control parameters for a harvest of pistachios to account for individual crop variability in moisture content;
placing said pistachios into a drying system;
utilizing statistical process control software and said control parameters to manage said drying system, monitoring said pistachios and adjusting said drying system using a method comprising:
controlling a temperature of each of a plurality of drying zones in said drying system such that an first kernel temperature of said pistachios remains below about 140° F.;
controlling belt speed of each of said plurality of drying zones to control drying time such that said first kernel temperature of said pistachios remains below about 140° F.; and
processing said pistachios in said drying system until a first humidity of said pistachios is reduced to about 12%;
moving said pistachios from said drying system to a storage container capable of blowing air on said pistachios; and
maintaining said pistachios in said container such that at a second kernel temperature of said pistachios remains below about 100° F. until a second humidity of said pistachios is reduced to about 5%.

16. The method of claim 15 further comprising wherein said pistachios are roasted.

17. The method of claim 15 wherein said first kernel temperature remains below 130° F.

18. The method of claim 15 wherein said first kernel temperature remains below 125° F.

19. The method of claim 15 wherein said first kernel temperature remains at about 110° F.

20. The method of claim 15 wherein said blowing air is heated to remain at about 100° F. when said temperature of said air is less than about 60° F.

21. The method of claim 15 where said blowing air in said container is ambient air.

22. The method of claim 21 further comprising:
wherein said blowing air is heated during daytime; and
wherein said blowing air is turned off at night.

23. The method of claim 15 further comprising wherein said monitoring is performed hourly.

24. The method of claim 23 wherein said monitoring further comprises:
taking a sample of said pistachios from said drying system;
putting said sample and a temperature measuring device into a thermal insulated container; and
determining said first kernel temperature using said temperature measuring device.

25. The method of claim 15 wherein said drying system is selected from a group consisting of tray dryers, belt dryers, vertical fluidized bed ovens, horizontal fluidized bed ovens, spray dryers, impingement ovens, bin dryers, bed dryers, vertical continuous dryers, vertical cylindrical dryers, and funnel vertical dryers.
